(19) United States
(12) Patent Application Publication
(10) Pub. No.: US 2007/0009116 A1
(43) Pub. Date: Jan. 11, 2007

(54) Sound field microphone

(76) Inventor: Friedrich Reining, Vienna (AT)

Correspondence Address: BRINKS HOFER GILSON & LIONE, P.O. BOX 10395, CHICAGO, IL, 60610, US

(21) Appl. No.: 11/474,124

(22) Filed: Jun. 23, 2006

(30) Foreign Application Priority Data
Jun. 23, 2005 (EP) EP 05 450 110.1

(51) Int. Cl. H04R 3/00

(52) U.S. Cl. 381/122

(57) ABSTRACT

A sound field microphone is provided. The sound field microphone includes a plurality of pressure-gradient microphone capsules symmetrically arranged in three dimensional space on the sides of a virtual polyhedron. The virtual polyhedron defines a first volume. A solid body is located in a-space created between the plurality of microphone capsules. The solid body occupies a second volume which is in the range of between about 1% to about 65% of the first volume.

### BACKGROUND OF THE INVENTION

1. Priority Claim

This application claims the benefit of priority from European Patent Application No. EP 05450110.1 filed Jun. 23, 2005, which is incorporated by reference.

2. Technical Field

The invention relates to sound field microphone assemblies. In particular the invention relates to sound field microphones adapted to provide output signals equivalent to the output signals that would be provided by a plurality of co-incident microphones.

3. Related Art

Various solutions to the problem of determining the direction and position of a sound source relative to a detection point (or small detection area) have been proposed. Sound field microphones typically include multiple pressure-gradient microphones oriented in different directions. The individual pressure-gradient microphones may be referred to as microphone capsules or simply as capsules. Each individual capsule may have its own directivity pattern. The signals from each capsule may be combined and manipulated in a manner that alters the overall directivity of the of the sound field microphone.

Several different orientation patterns have been employed for positioning the individual microphone capsules of sound field microphones. One system employs a microphone array in which a plurality of capsules are mounted equidistant from one another in a ring-like structure. This arrangement, however, may only distinguish the direction of sound within a common plane of the microphone capsule array. In another system six small pressure-sensitive omnidirectional microphones are flush mounted on the surface of a rigid nylon sphere at the vertices of a virtual octahedron. However, In this arrangement the nylon sphere adversely effects the quality of the resulting signal.

In another arrangement the back sides of the capsules may be arranged on the tangential surfaces of an imaginary sphere having the largest possible symmetry. A problem with this arrangement is that the physical presence of other capsules in the array exerts a significant influence on the signals received by the individual capsules within the array. The pressure-gradient capsules react only to the difference in sound pressure between the front of the membrane and the back of the membrane within the capsules. The presence of other nearby capsules behind an individual capsule may affect the sound waves centering the back side of the capsule membrane This may alter the output signal of the capsule relative to the output signal of a similarly placed capsule.

The cavity formed in the interior of a microphone capsule assembly may act as an acoustic filter. The acoustic filtering may be frequency-dependent and may have a stronger effect at some frequencies rather than others. For example, the filtering effect may be strongest a frequencies at which the wavelength of the sound is essentially the same order of magnitude as the dimensions of the membrane or the dimensions of the entire sound field microphone assembly. In some sound field microphones the filtering caused by the internal cavity between microphone capsules affects the frequency ranges around 10 kHz. At this frequency signal attenuation may not be uniform, or particularly strong.

A need exists for a sound field microphone that blocks or attenuates sounds that are received from directions in which the individual microphones have the least sensitivity. There also is a need for a sound field microphone that blocks or attenuates signals uniformly across a specified frequency range.

### SUMMARY

A sound field microphone is disclosed. The sound field microphone includes a plurality of pressure gradient microphone capsules symmetrically arranged on the sides of a virtual polyhedron. The sides of the virtual polyhedron are tangent to an imaginary circle having a largest possible symmetry. The polyhedron may be a tetrahedron, a hexahedron, a dodecahedron, an icosahedron, other regular polyhedron. The virtual polyhedron defines a first volume. A solid body is located in a space created between the plurality of microphone capsules. The solid body may have the shape of a sphere occupying up to about 30.2% of the volume of the virtual polyhedron. The shape of the solid body deviates from that of sphere but nonetheless remains substantially spherical, the solid body may occupy up to about 40% of the volume of the virtual polyhedron. Alternatively, the solid body may have the shape of a flattened sphere occupying up to about 65% of the volume of the virtual polyhedron. The solid body occupies a minimum of about 1% of the volume to the virtual polyhedron. The solid body may be made of an elastomeric material such as silicone, or some other material, including wood, metal, ceramic, or other material. The solid body may include mounting structures for receiving the microphone capsules, and orienting the capsules relative to one another.

Other systems, methods, features and advantages of the invention will be, or will become, apparent to one with skill in the art upon examination of the following figures and detailed description. It is intended that all such additional systems, methods, features and advantages be included within this description, be within the scope of the invention, and be protected by the following claims.

### BRIEF DESCRIPTION OF THE DRAWINGS

The invention may be better understood with reference to the following drawings and description. The components in the figures are not necessarily to scale, emphasis instead being placed upon illustrating the principles of the invention. Moreover, in the figures, like referenced numerals designate corresponding parts throughout the different views.

FIG. 1 is a side view of the geometric arrangement of a sound field.

FIG. 2 is a top view of the geometric arrangement of a sound field microphone.

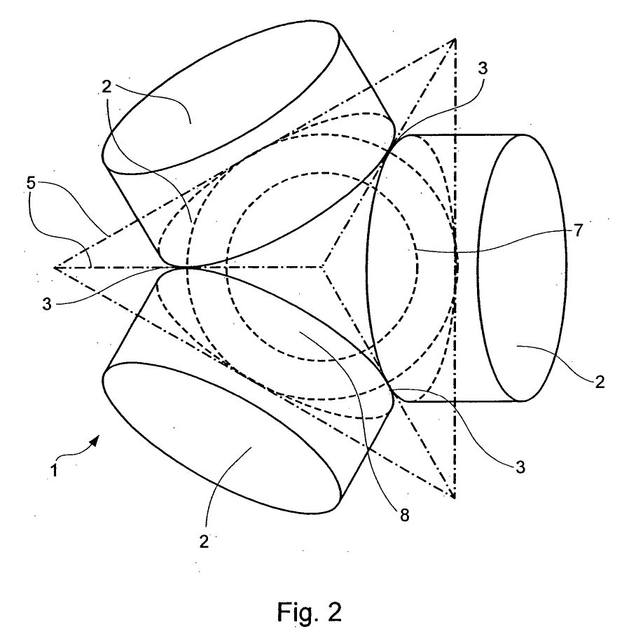

FIG. 3 is a frequency v. amplitude plot showing the rejection curve for a sound field microphone according to the invention, with additional reference curves for comparison.

FIG. 4 is a front view showing the arrangement of microphone capsules in a second-order sound field microphone.

FIG. 5 is a three dimensional representation of a solid body in the shape of a flattened sphere based on a tetrahedron capsule arrangement.

FIG. 6 is a three dimensional representation of a solid body in the shape of a flattened sphere based on a dodecahedron capsule arrangement.

### DETAILED DESCRIPTION OF THE PREFERRED EMBODIMENTS

A sound field microphone is provided having a plurality of pressure-gradient microphone capsules or other transducers that convert sound into analog or digital signals. The back sides of the capsules are arranged in space on tangential surfaces of an imaginary sphere having the largest possible symmetry. In other words, the capsules are arranged on the surfaces of a virtual, regular polyhedron, such as a tetrahedron, hexahedron, octahedron, dodecahedron, icosahedron, or other geometric solid. In a sound field microphone having four capsules the capsules may be arranged on the faces of a tetrahedron such that the membranes of the individual capsules are substantially parallel to the surfaces of the virtual tetrahedron.

Each capsule delivers its own signal. A sound field microphone having four capsules will deliver four signals A, B, C, and D. Furthermore, each individual microphone capsule may have a directivity pattern that deviates from an omni-directional pattern. An individual microphone's capsules directivity pattern may be represented in the form (1−k)+k×cos(θ), where θ denotes the azimuth under which the capsule is exposed to sound, and k is a ratio factor that designates how strongly the signal deviates from an omnidirectional signal. For example in a sphere, k=0; in a figure-eight, k=1. The axis of symmetry of the directivity pattern of each individual microphone may be perpendicular to the membrane or to the corresponding face of the tetrahedron. The axes of symmetry of the directivity pattern of each individual capsule (also called the main direction of the individual capsule) therefore together enclose an angle of about 109.5°.

The four individual signals from each capsule may be converted to a so-called B format (W, X, Y, Z). The calculation procedure is:
W=½(A+B+C+D)
X=½(A+B−C−D)
Y=½(−A+B+C−D)
Z=½(−A+B−C+D)
The directivity of the forming signals may be described in terms of spherical harmonics. The signals include one sphere (W) and three figure-eights (X, Y, Z) orthogonal to each other. A sound field microphone of this type may be referred to as a first-order sound field microphone. A first-order sound field microphone creates signals with spherical harmonics up to the first order.

A second order sound field microphone requires, for example, twelve individual gradient microphone capsules. A second order sound field microphone may include twelve individual pressure gradient microphone capsules. In this case the microphone capsules may be arranged in the form of a dodecahedron where each face of the dodecahedron carries a capsule. A Cartesian coordinate system may be established in order to define normal vectors perpendicular to each capsule. If two auxiliary quantities are introduced:
x⁺=\sqrt{1/10}\sqrt{5+\sqrt{5}}=1/10 \sqrt{50+10 \sqrt{5}}
x⁻=\sqrt{1/10}\sqrt{5−\sqrt{5}}=1/10 \sqrt{50−10 \sqrt{5}}
the normal vectors a may be written simply as:
û_{—1} [x⁺0 x⁻]^{T}
û_{—2} [x⁺0 x⁻]^{T}
û_{—3} [−x⁺0 x⁻]^{T}
ŷ_{—4} [−x⁺0 −x⁻]^{T}
û_{—5} [x⁻x⁺0]^{T}
û_{—6} [−x⁻x⁺0]^{T}
û_{—7} [x⁻−x⁺0]^{T}
û_{—8} [−x⁻−x⁺0]^{T}
û_{—9} [0 x⁻x⁺]^{T}
û_{—10} [0 −x⁻x⁺]^{T}
û_{—11} [0 x⁻−x⁺]^{T}
û_{—12} [0 −x⁻−x⁺]^{T}

The B format with the known zero order and first-order signals W, X, Y, Z may be expanded by additional signals corresponding to the second-order spherical signal components. These signals may be denoted with the letters R, S, T, U, and V. The relationships between the capsule signals s1, s1 . . . s12 and the corresponding Y, Z, R, S, T, U, and V are shown in the following Table 1.

TABLE 1

| | W | X | Y | Z | R | S | T | U | V |
|---|---|---|---|---|---|---|---|---|---|
| s1 | $\frac{1}{12}$ | $\frac{1}{4} {x}^{+}$ | 0 | $\frac{1}{4} {x}^{-}$ | $\frac{\sqrt{5}}{48}$ $( \sqrt{5} - 3 )$ | $\frac{\sqrt{5}}{6}$ | 0 | $\frac{\sqrt{5}}{24}$ $( 1 + \sqrt{5} )$ | 0 |
| s2 | $\frac{1}{12}$ | $\frac{1}{4} {x}^{+}$ | 0 | $- \frac{1}{4} {x}^{-}$ | $\frac{\sqrt{5}}{48}$ $( \sqrt{5} - 3 )$ | $- \frac{\sqrt{5}}{6}$ | 0 | $\frac{\sqrt{5}}{24}$ $( 1 + \sqrt{5} )$ | 0 |
| s3 | $\frac{1}{12}$ | $- \frac{1}{4} {x}^{+}$ | 0 | $\frac{1}{4} {x}^{-}$ | $\frac{\sqrt{5}}{48}$ $( \sqrt{5} - 3 )$ | $- \frac{\sqrt{5}}{6}$ | 0 | $\frac{\sqrt{5}}{24}$ $( 1 + \sqrt{5} )$ | 0 |
| s4 | $\frac{1}{12}$ | $- \frac{1}{4} {x}^{+}$ | 0 | $- \frac{1}{4} {x}^{-}$ | $\frac{\sqrt{5}}{48}$ $( \sqrt{5} - 3 )$ | $\frac{\sqrt{5}}{6}$ | 0 | $\frac{\sqrt{5}}{24}$ $( 1 + \sqrt{5} )$ | 0 |
| s5 | $\frac{1}{12}$ | $\frac{1}{4} {x}^{-}$ | $\frac{1}{4} x$ | 0 | $- \frac{5}{24}$ | 0 | 0 | $- \frac{\sqrt{5}}{12}$ | $\frac{\sqrt{5}}{6}$ |
| s6 | $\frac{1}{12}$ | $- \frac{1}{4} {x}^{-}$ | $\frac{1}{4} x$ | 0 | $- \frac{5}{24}$ | 0 | 0 | $- \frac{\sqrt{5}}{12}$ | $- \frac{\sqrt{5}}{6}$ |
| s7 | $\frac{1}{12}$ | $\frac{1}{4} {x}^{-}$ | $- \frac{1}{4} x$ | 0 | $- \frac{5}{24}$ | 0 | 0 | $- \frac{\sqrt{5}}{12}$ | $- \frac{\sqrt{5}}{6}$ |
| s8 | $\frac{1}{12}$ | $- \frac{1}{4} {x}^{-}$ | $- \frac{1}{4} x$ | 0 | $- \frac{5}{24}$ | 0 | 0 | $- \frac{\sqrt{5}}{12}$ | $\frac{\sqrt{5}}{6}$ |
| s9 | $\frac{1}{12}$ | 0 | $\frac{1}{4} x$ | $\frac{1}{4} {x}^{+}$ | $\frac{\sqrt{5}}{48}$ $( \sqrt{5} + 3 )$ | 0 | $\frac{\sqrt{5}}{6}$ | $\frac{\sqrt{5}}{24}$ $( 1 - \sqrt{5} )$ | 0 |
| s10 | $\frac{1}{12}$ | 0 | $- \frac{1}{4} x$ | $\frac{1}{4} {x}^{+}$ | $\frac{\sqrt{5}}{48}$ $( \sqrt{5} + 3 )$ | 0 | $- \frac{\sqrt{5}}{6}$ | $\frac{\sqrt{5}}{24}$ $( 1 - \sqrt{5} )$ | 0 |
| s11 | $\frac{1}{12}$ | 0 | $\frac{1}{4} x$ | $- \frac{1}{4} {x}^{+}$ | $\frac{\sqrt{5}}{48}$ $( \sqrt{5} + 3 )$ | 0 | $- \frac{\sqrt{5}}{6}$ | $\frac{\sqrt{5}}{24}$ $( 1 - \sqrt{5} )$ | 0 |
| s12 | $\frac{1}{12}$ | 0 | $- \frac{1}{4} x$ | $- \frac{1}{4} {x}^{+}$ | $\frac{\sqrt{5}}{48}$ $( \sqrt{5} + 3 )$ | 0 | $\frac{\sqrt{5}}{6}$ | $\frac{\sqrt{5}}{24}$ $( 1 - \sqrt{5} )$ | 0 |

An advantage of sound field microphones is that it is possible to alter the directivity patterns of the entire microphone by deduction of individual signals after particular sound events have been recorded. The directivity patterns may be adapted in a desired manner even during playback or final production of the sound carrier. It may be possible, for example, to emphasize soloists in an ensemble. It may also be possible to mask unexpected or undesired sound events influencing the directivity patterns of the sound field microphone. Or it may be possible to follow a moving sound source, such as an actor on a stage, so that the recording quality is retained regardless of the changing position of the sound source.

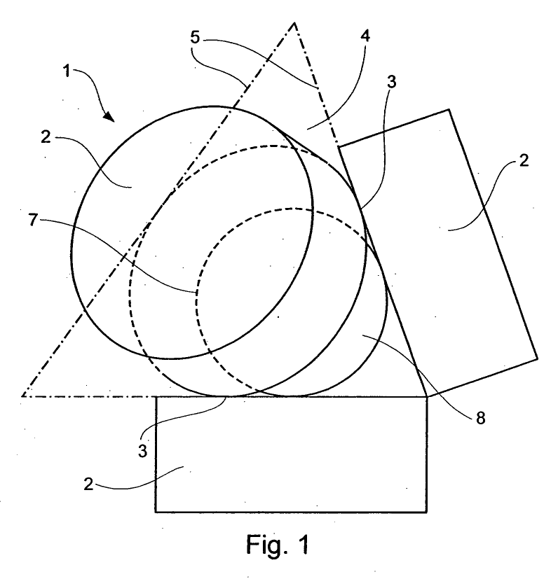

FIG. 1 is a side view of the spatial arrangement of the pressure-gradient microphone capsules of a first order sound field microphone. The first order sound field microphone includes four cylindrical capsules 2 symmetrically arranged in a three dimensional tetrahedral configuration.

A common feature of tetrahedral arrangements of microphone capsules 2 in sound field microphones is that individual capsules contact one another at contact points 3. A virtual tetrahedron 4 is defined by the capsule arrangement. The contact points 3 between capsules 2 form the midpoints of the tetrahedral edge 5. An imaginary sphere 7 may be inscribed within the virtual tetrahedron 4. The sphere 7 bounded by the side surfaces of the virtual tetrahedron 4. Such that it touches the center of the back side of each of the individual capsules 2 is the largest sphere that may be contained within the bounds of the virtual tetrahedron. The following formula indicates the volume of the sphere 7 relative to the volume of the virtual tetrahedron 4 itself:
Vo1_{sphere/tetrahedron}=π/(6\sqrt{3})
or, expressed in numbers: the volume of sphere 7 is 30.2% of the volume of virtual tetrahedron 4.

A solid sphere of the size described above or smaller may be positioned within into the interior of the tetrahedral capsule arrangement. If the sound inputs on the back side of the individual capsules are situated radially farther from the center or on an outer surface of the capsules surfaces they will not be covered by the sphere. However, further enlargement of the sphere, accompanied by a flattening of the sphere at each contact surface with the capsules, may cause the sound inputs of the individual capsules to be increasingly influenced by the sphere. If the sound inputs on the backsides of the capsules are completely covered the capsules will no longer function as pressure-gradient transducers.

As indicated above, a solid spherical body introduced in the space between the capsules 2 will have an upper volume limit of 30.2% of the volume of the virtual tetrahedron 4. The upper volume limit of a body introduced in the space between the capsules may be increased to a maximum of about 40% of the virtual tetrahedron if the shape of the body is slightly modified but remains essentially spherical. For a spherically flattened body a maximum of about 65% of the volume of the virtual tetrahedron may be achieved.

A body referred to as “spherically flattened” may have essentially the shape of an element that would form if an air balloon were inflated within the space between the microphone capsules. If the balloon were over inflated such that it finally touched the back sides of the capsules and swelled a little further, the shape would still be generally spherical, but with flattened portions corresponding to the locations of the individual capsules. If such an element solidified, it would acquire circular impressions from each capsule with an annular shoulders on its surface. Such body will no longer be spherical in the gussets between the capsules, but will be more tetrahedral in this case its relative volume can be much greater than the 40% limit provided by the essentially spherical body, up to about 65% of the volume of the virtual tetrahedron. Nonetheless, the sound-entry openings for the back side of the membrane of the capsules must remain free of the spherically flattened body formed in this manner.

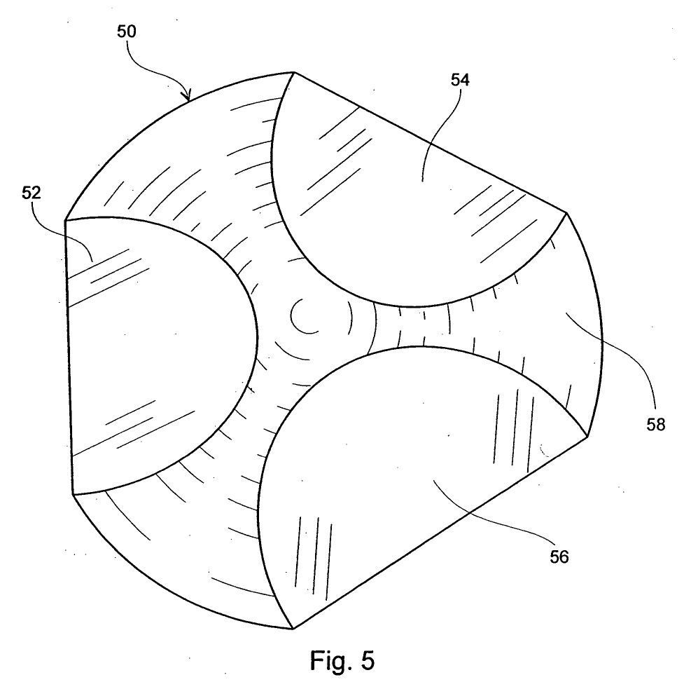

FIG. 5 is a three dimensional representation of a solid body 50 in the shape of a flattened sphere, the solid body 50 is adapted to be inserted into a sound field microphone in which the microphone capsules are arranged on the surfaces of a virtual tetrahedron. The solid body 50 is substantially spherical, but includes flattened portions 52, 54, and 56 corresponding to the locations of the microphone capsules. A fourth flattened area, not visible in FIG. 5, is located on the opposite side of the solid body 50.

The beneficial effects of inserting a solid body into the space between the capsules diminish with the reduced size of the solid body. Nonetheless, a spherical body having a diameter ⅓ the diameter of the largest sphere that may be inscribed within the virtual tetrahedron still has positive benefits when positioned in the space between the microphone capsules of a sound field microphone. Reducing the diameter of the sphere by ⅓ reduces the volume of the sphere to about 3.7% of the original sphere. This results in a reduction to about 1% of the total volume of the virtual tetrahedron. Thus, a spherical solid body may be advantageously incorporated within the space between the microphone capsules of a sound field microphone within the volumetric limits of from about 1% to 40% of the volume of the virtual tetrahedron 4 formed by the capsule arrangement if the solid body is substantially spherical. If the solid body is in the shape of flattened sphere, it may occupy up to about 65% of the volume of the virtual tetrahedron.

The material forming the solid body can be chosen over broad limits without impacting the desired results. The introduced object may be plastic, both elastomeric or rubber-like material, metal, ceramic, glass, or wood. The surface characteristics of the solid body have little or no impact on the quality of the signals received by the sound field microphone. However, porous materials such as foam have no effect.

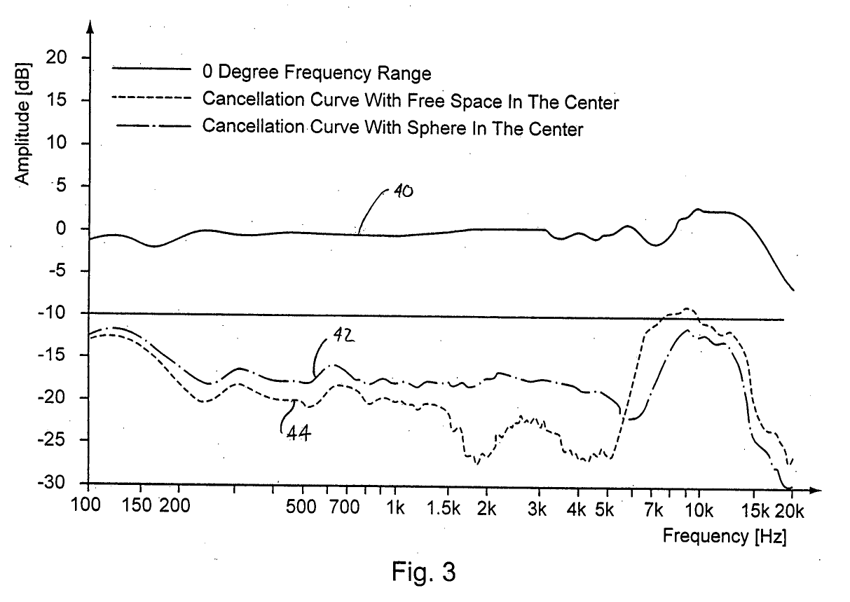

FIG. 3 shows rejection curves of a single capsule of a sound field microphone. Separate curves are provided representing the frequency rejection curves for the capsule when a solid body is incorporated in the sound field microphone and when a solid body is omitted. A 0° frequency response across the entire frequency range is also provided. For this plot of a sphere made of silicone (Elastil) with a volume fraction of about 34% in reference to the virtual tetrahedron was incorporated in the interior of the said sound field microphone.

The curve 40 running close to 0 dB over almost the entire frequency range represents the 0 curve. This curve represents sound entering the capsule from the direction in which the microphone has the greatest sensitivity. The rejection curve of the capsule according to the prior art 34 is more strongly influenced and includes two pronounced local minima. The rejection curve of the same capsule with the solid body included in the sound field microphone assembly is even more strongly influenced, with only one local minimum lying at higher frequencies.

Rejection of the capsule when the solid body was absent is better than in the capsule when the solid body was present at frequencies below about 6 KHZ in a sound field. Nonetheless rejection of the capsule equipped with the solid body is strong, and remains below −10 dB throughout the entire frequency range. The fact that the frequency response remains below −10 dB throughout the entire frequency range is more significant than the loss of rejection in the lower-frequency ranges. The differences between −16 dB and −22 or −24 dB that exist at the lower frequencies between the capsule with and without the solid body present are not as important to the listening experience as are the difference of between about −8 or −12 dB, at 10 KH.

The sound field microphone and the solid body incorporated within the sound field microphone may be modified in many different ways. For example, it is possible to provide the annular membrane capsule mounts on the surface of the solid body. The capsule mounts may be provided with sound-entry openings, which lead to the back side of the corresponding membranes. Alternately it may also be possible to equip a spherically flattened element with annular seats corresponding to the locations of the capsules. The annular seats may accommodate the inner edges of mounting rings associated with the capsules, or otherwise to support the capsules against body, thus such mounting structures may be provided for positioning and securing the capsule to the solid body without additional components.

A sphere may be made to press against all force systems of the microphone assembly from the rear. This may be advantageous for purposes of tolerance compensation during assembly of the sound field microphone in this way mounting structures and other components for maintaining the desired spatial geometry of the capsules may be eliminated.

When the incorporated body has a substantially spherical shape the annular seats may be unnecessary. When the spherical diameter is adjusted due to the geometry of the sound field microphone, the sphere may be held in place by the internal edges of the membrane mounting rings of the individual capsules. Such an arrangement is enhanced when the introduced body has a certain elasticity, for example, when the solid body is formed of an elastomeric material. In this case the mechanical design can therefore be simplified

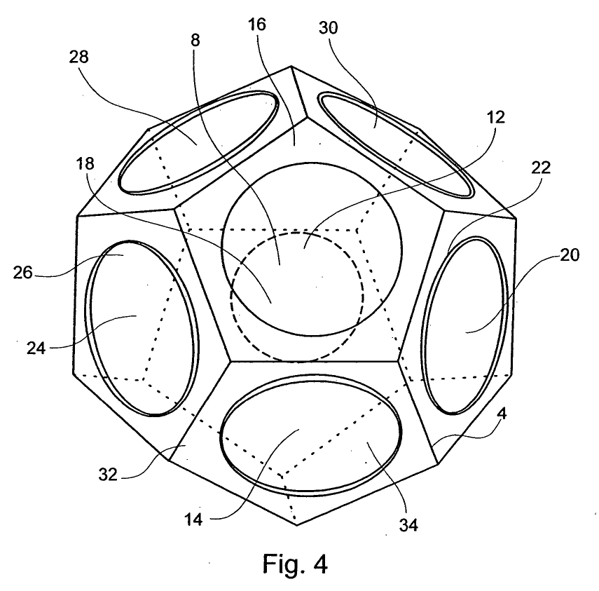

Similar considerations apply regarding the volume of a solid body in relation to the volume of a regular polyhedron of sound field microphones comprising more than four capsules. Alternative sound field microphones may have multiple capsules arranged on the surfaces of a hexahedron, octahedron, dodecahedron, or other geometric solid. In FIG. 4 the solid body 8 is a sphere arranged in the center of a dodecahedron. Again, the volume of the solid body 8 may to be at least about 1% of the volume of the regular polyhedron to achieve the desired beneficial effects.

The sound field microphone shown in FIG. 4 is a second order sound field microphone with twelve capsules 12, 14, 16, 18, 20, 22, 24, 26, 28, 30, 32, and 34 spatially aligned in a symmetrical pattern on the surfaces of a dodecahedron. The concepts described above may be applied to any kind of sound field microphone, whose capsules are arranged on a virtual essentially regular polyhedron, e.g. a tetrahedron, hexahedron, octahedron, dodecahedron or other polyhedron with a corresponding number of capsules (four, six, eight, twelve, twenty, etc.)

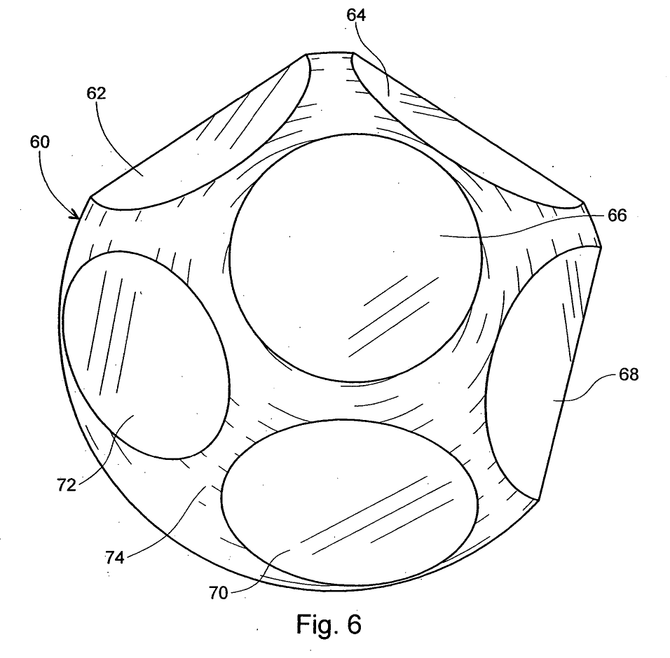

FIG. 6 is a three dimensional representation of a solid body 60 in the shape of a flattened sphere to be inserted into a sound field microphone in which the microphone capsules are located on the surfaces of a dodecahedron. Again, the solid body 60 is substantially spherical, but having flattened portions 62, 64, 66, 68, 70, and 72 corresponding to the locations of the microphone capsules. Additional flattened areas located on the opposite side of the solid body 60 are not visible in FIG. 6.

While various embodiments of the invention have been described, it will be apparent to those of ordinary skill in the art that many more embodiments and implementations are possible within the scope of the invention. Accordingly, the invention is not to be restricted except in light of the attached claims and their equivalents.

I claim:

1. A sound field microphone comprising:
a plurality of pressure gradient microphone capsules symmetrically arranged in space on the sides of a virtual polyhedron, the virtual polyhedron defining a first volume; and
a solid body located in a space between the plurality of microphone capsules, the solid body occupying a second volume greater than about 1% of the first volume defined by the polyhedron.

2. The sound field microphone of claim 1 where the polyhedron comprises one of a tetrahedron; a hexahedron; an octahedron; a dodecahedron; or an icosahedron.

3. The sound field microphone of claim 1 where the solid body is sized to substantially fill the space between the microphone cells.

4. The sound field microphone of claim 1 where the solid body has a substantially spherical shape and occupies a volume comprising approximately 40% of the first volume defined by the virtual polyhedron.

5. The sound field microphone of claim 1 where the solid body has a spherically flattened and occupies a volume up to 65% of the volume defined by the virtual polyhedron.

6. The sound field microphone of claim 5 further comprising positioning elements on flattened portions of the solid body for locating the microphone capsules.

7. The sound field microphone of claim 6 where the microphone capsules physically engage the flattened portions of the solid body.

8. The sound field microphone of claim 1 where the solid body comprises an elastomeric material.

9. The sound filed microphone of claim 1 where the solid body comprises silicone.

10. A method of creating a sound field microphone comprising:
defining a virtual polyhedron;
arranging a plurality of microphone capsules in a spherically symmetric manner on surfaces of the virtual polyhedron; and
providing a solid body within a space between the plurality of microphone capsules.

11. The method of claim 10 where the virtual polyhedron defines a first volume, and the solid body occupies a second volume that is a fraction of the first volume.

12. The method of claim 11 where the second volume falls within the range from about 1% to about 65% of the first volume.

13. The method of claim 10 where the solid body is in the shape of a sphere occupying up to about 30.2% of a volume defined by the polyhedron.

14. The method of claim 10 where the solid body has the shape of a flattened sphere created by forming flattened surfaces on an outer surface of a sphere at positions corresponding to the spatially arranged microphone capsules, the flattened sphere occupying up to about 65% of a volume defined by the virtual polyhedron.

15. The method of claim 14 further comprising forming the solid body of an elastomeric material and providing mounting structures on the solid body to orient the microphone capsules.

16. A sound field microphone comprising:
a plurality of pressure-gradient microphone capsules arranged in a spherically symmetric pattern on tangential planes of an imaginary sphere having the largest possible symmetry; and
a solid body disposed within a space between the plurality of microphone cells.

17. The sound field microphone of claim 16 where the tangential planes on which the microphone capsules define a virtual polyhedron defining a first volume, and where the solid body occupies a second volume less than the first volume.

18. The sound field microphone of claim 17 where the solid body is substantially spherical occupying a volume in the range from about 1% to about 40% of the first volume defined by the virtual polyhedron.

19. The sound field microphone of claim 17 where the solid body comprises a flattened sphere having flattened surfaces corresponding to locations of the microphone capsules.

20. The sound field microphone of claim 19 where the solid body occupies a volume up to about 65% of the volume of the virtual polyhedron.

21. The sound field microphone of claim 19 where the flattened surfaces of the solid body include mounting structures adapted to receive the microphone capsules.

22. The sound field microphone of claim 17 where the virtual polyhedron defined by the arrangement of the microphone capsules comprises one of: a tetrahedron, a hexahedron; an octahedron, a dodecahedron, or an icosahedron.

23. A sound field microphone comprising:
a plurality of microphone capsules arranged on the outer surface of an imaginary sphere in a symmetrical pattern such that tangential planes corresponding to each microphone capsule provide a largest possible symmetry and define a virtual regular polyhedron; and
a solid body disposed within a space bounded by the plurality of microphone capsules.

24. The sound field microphone of claim 23 where the solid body comprises silicone.

25. The sound field microphone of claim 23 where the solid body comprises elastomeric material.

26. The sound field microphone of claim 23 where the solid body occupies between about 1% to about 65% of a volume defined by the virtual regular polyhedron.

27. The sound field microphone of claim 23 where the solid body has a shape of a sphere.

28. The sound field microphone of claim 23 where the solid body is in the shape of a flattened sphere having flat surfaces corresponding to the locations of the microphone capsules.

29. The sound field microphone of claim 28 where the flat surfaces of the flattened sphere include mounting means for receiving the microphone capsules.

30. The sound field microphone of claim 23 comprising four microphone capsules arranged on the surfaces of a virtual tetrahedron.

31. The sound field microphone of claim 23 comprising six microphone capsules arranged on the surfaces of a virtual hexahedron.

32. The sound field microphone of claim 23 comprising twelve microphone capsules arranged on the surfaces of a virtual dodecahedron.

33. The sound field microphone of claim 23 comprising eight microphone capsules arranged on the surfaces of a virtual octahedron.

34. The sound field microphone of claim 23 comprising twenty microphone capsules arranged on the surface of a virtual icosahedron.
